(19) United States
(12) Patent Application Publication
(10) Pub. No.: US 2005/0065934 A1
(43) Pub. Date: Mar. 24, 2005

(54) System, method, and computer program for managing address data

(76) Inventors: Keisuke Kataoka, Kanagawa (JP); Tatsuto Torikai, Kanagawa (JP); Atsushi Hanai, Kanagawa (JP); Kohichi Yuasa, Tokyo (JP); Sachiko Misumi, Tokyo (JP); Eiji Shinohara, Kanagawa (JP); Akihiro Kanomune, Kanagawa (JP); Ruriko Sakane, Kanagawa (JP); Yuuichi Fukada, Tokyo (JP); Mutsuko Takahashi, Tokyo (JP)

Correspondence Address: MORRISON & FOERSTER LLP, 1650 TYSONS BOULEVARD, SUITE 300, MCLEAN, VA, 22102, US

(21) Appl. No.: 10/665,396

(22) Filed: Sep. 22, 2003

(30) Foreign Application Priority Data
Sep. 19, 2002 (JP) 2002-273543

(51) Int. Cl. G06F 7/00

(52) U.S. Cl. 707/9

(57) ABSTRACT

An identification data receiving unit receives identification data of a user sent from a user terminal. An address data extracting unit extracts an address data from a group identification file provided in an address data storing unit, based on the identification data received by the identification data receiving unit. An address output processing unit sends the address data extracted by the address data extracting unit. A change request receiving unit receives a request for changing the identification data of the user sent from the user terminal, and the address data. A change processing unit changes the group identification file provided in the address data storing unit, and the data stored in an address management database.

### BACKGROUND OF THE INVENTION

1. Field of the Invention

The present invention relates to a system, method, and computer program for managing address data.

2. Description of the Related Art

When an employee of a company purchases merchandise for business purposes, it is general for a receiver and a payer of merchandise to be designated by referring to an address list created beforehand, The address list is stored in one or a plurality of computer systems as digital data. A user can read the address list by accessing to the address list by a predetermined terminal. The address list is put into one or a plurality of files, for a plurality of stores, or for an entire company.

A group composed of the plurality of stores, and the entire company, has many people or organizations to be designated as the receiver and payer of merchandise. For example, hundreds of people or organizations may be registered as the receiver and payer of merchandise. In this kind of situation, it is difficult for the user to select the receiver and payer of merchandise by referring to the address list. As more people and organizations are registered in the address list, it becomes more difficult for the user to select the receiver and payer of merchandise.

### SUMMARY OF THE INVENTION

The object of the present invention is to make it possible for a user to effectively select a receiver and a payer of merchandise.

To achieve the object, according to the present invention, a system for managing address data comprising:
an address data storing unit which stores address data of users that are categorized based on groups in which each of the users belong to, and identification data unique to the users;
an identification data receiving unit which receives identification data of the users from user terminals;
an address data extracting unit which extracts address data, corresponding to the identification data received by the identification data receiving unit, from the address data stored in the address data storing unit; and
an address data output processing unit which outputs the address data extracted by the address data extracting unit to respective one of user terminals.

According to this structure, it is possible for the address data corresponding to the identification data to be extracted from the address data storing unit, when the user terminal sends the identification data of the user. Therefore, because the adequate address data corresponding to the user is provided, the user can effectively select the receiver and payer of merchandise.

The system may further comprise:
a change request receiving unit which receives identification data of a user, and a request for changing the address data; and
a change processing unit which changes the address data stored in the address data storing unit, in response to the request received from the change request receiving unit,
wherein:
the request received from the change request receiving unit may include a first request for inserting address data, and a second request for deleting address data; and
the change processing unit:
may insert new address data corresponding to the identification data of the user to the address data stored in the address data storing unit, when the change request receiving unit receives the first request; and
may delete a part of or the whole address data stored corresponding to the user in the address data storing unit, when the change request receiving unit receives the second request.

The address data stored in the address data storing unit may include receiver data showing the receiver of a merchandise, and payer data showing the payer of the merchandise wherein:
the address data extracting unit may read the receiver data and the payer data from the address data storing unit, in accordance with the identification data of the user received by the identification data receiving unit; and
the address data output unit may send the receiver data and the payer data read by the address data extracting unit, to the user terminal.

A method according to the present invention comprising:
storing address data of users, categorized based on groups in which each of users belong to, and identification data unique to each of the users, in a storing unit;
receiving identification data of a user from a user terminal;
reading address data, corresponding to the received identification data, from the data storing unit; and
providing read address data to a respective user terminal.

The method may further comprise:
receiving a request for changing the identification data of the user, and the address data, from the user terminal;
inserting new address data, corresponding to the identification data of the user, to the address data stored in the address data storing unit, when the request received from the user terminal is a first request for inserting address data; and
deleting a part of or the whole address data stored corresponding to the user in the address data storing unit, when the request received from the user terminal is a second request for deleting address data.

The address data stored in the data storing unit may include a receiver data that shows a receiver of a merchandise, and a payer data that shows a payer of a merchandise.

The receiver data and the payer data stored in the data storing unit may be read, in accordance with the identification data of the user received by the user terminal, and the read receiver data and the payer data may be sent to the user terminal.

According to the present invention, a computer program comprising instructions for:
storing address data, categorized based on a group in which a user belongs to, and an identification data unique to the user in a storing unit;
receiving identification data of the user from a user terminal;
reading address data, corresponding to the received identification data, from the data storing unit; and
providing the read address data to the user terminal.

The computer program may further comprise:
receiving a request for changing the identification data of the user, and the address data, from the user terminal;
inserting new address data, corresponding to the identification data of the user, to the address data stored in the address data storing unit, when the request received from the user terminal is a first request for inserting address data; and
deleting a part of or the whole address data stored corresponding to the user in the address data storing unit, when the request received from the user terminal is a second request for deleting address data.

The address data stored in the data storing unit may include a receiver data that shows a receiver of a merchandise, and a payer data that shows a payer of a merchandise.

The computer program may further read the receiver data and the payer data from the data storing unit, in accordance with the identification data of the user received by the user terminal, and comprise an instruction for sending the read receiver data and the payer data to the user terminal.

### BRIEF DESCRIPTION OF THE DRAWINGS

These objects and other objects and advantages of the present invention will become more apparent upon reading of the following detailed description and the accompanying drawings in which:

FIG. 1 is a block diagram showing the structure of an address data management system;

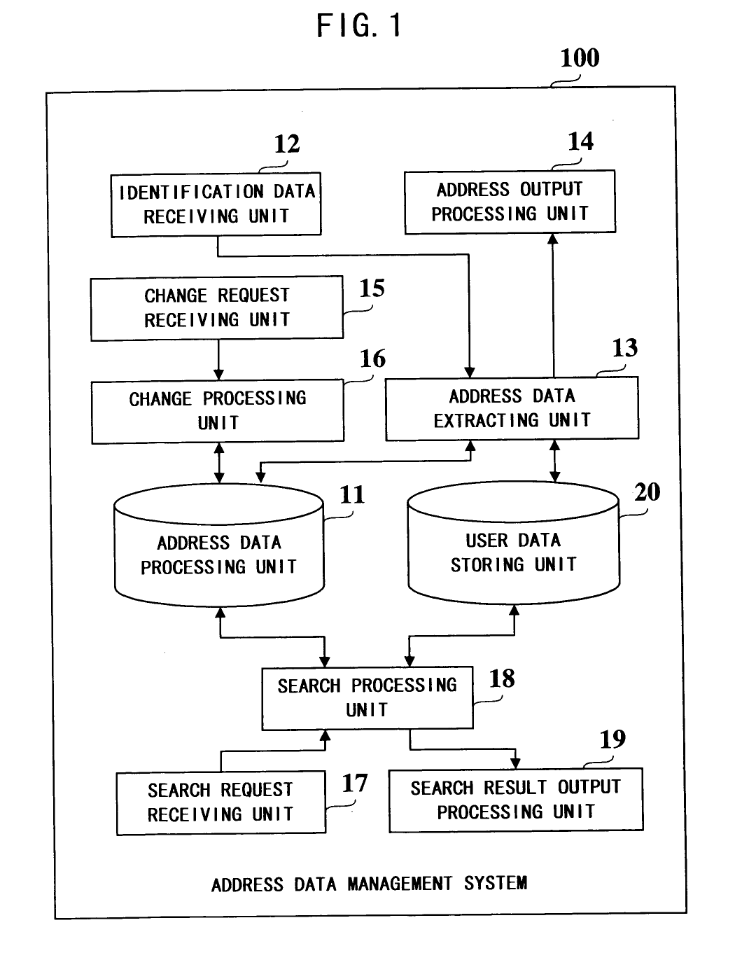

FIG. 2 is an example of a network system in which the system shown in FIG. 1 is applied;

FIG. 3A is an example of a data structure in the group identification file;

FIG. 3B is an example of a data structure in the user identification table;

FIG. 4 is an example of a data structure in the address management database;

FIG. 5 is an example of a data structure in the user management database;

FIG. 6 is a flowchart showing the search processing;

FIG. 7 is an example of an image displayed by the user terminal;

FIG. 8 is a flowchart showing the customize processing;

FIG. 9 is a flowchart showing the selection processing; and

FIG. 10 is an example of an image displayed by the user terminal.

### DETAILED DESCRIPTION OF THE PREFERRED EMBODIMENT

According to the present invention, an address data management system 100 comprises an address data storing unit 11, an identification data receiving unit 12, an address data extracting unit 13, and an address data output-processing unit 14. The address data storing unit 11 is used for storing address data in the address data system 100. The address data is categorized based on a group in which a user belongs to, and an identification data unique to the user in the group. For example, the groups in which the user belongs to, are companies, stores, and etc. The identification data receiving unit 12 receives identification data of the user in a predetermined group, from an external device (for example a user terminal 300, which will be described later on). The address data extracting unit 13 extracts address data from the data stored in the address data storing unit 11, based on the identification data received from the identification data receiving unit 12. The address data output processing unit 14 sends the address data extracted from the address data extracting unit 13 to the external device.

Additionally, the address data management system 100 comprises a change request receiving unit 15, and a change processing unit 16. The change request receiving unit 15 receives a request for changing the identification data of the users, and the address data. In one case, a request received by the change request receiving unit 15, instructs the address data correlating with the identification data of the users to be inserted to the data stored in the address data storing unit 11. In another case, a request received by the change request receiving unit 15, instructs the data correlating with the identification data of the users, stored in the address data storing unit 11, to be deleted. The change processing unit 16 carries out processing for changing the data stored in the address data storing unit 11, based on the request received by the change request receiving unit 15.

Furthermore, the address data management system 100 comprises a search request receiving unit 17, a search processing unit 18, a search result output processing unit 19, and a user data storing unit 20. The search request receiving unit 17 receives search request inputted by the external device. The search processing unit 18 searches for the instructed data from the data stored in the address data storing unit 11, based on the request received from the search request receiving unit 17. The search result output processing unit 19 sends the data of the result of the search by the search processing unit 18. The user data storing unit 20 is used for storing the identification of users in the address data management system 100. The identification data of the users stored in the user data storing unit 20 is used for the authentication of users by the address data extracting unit 13, and the search processing unit 18.

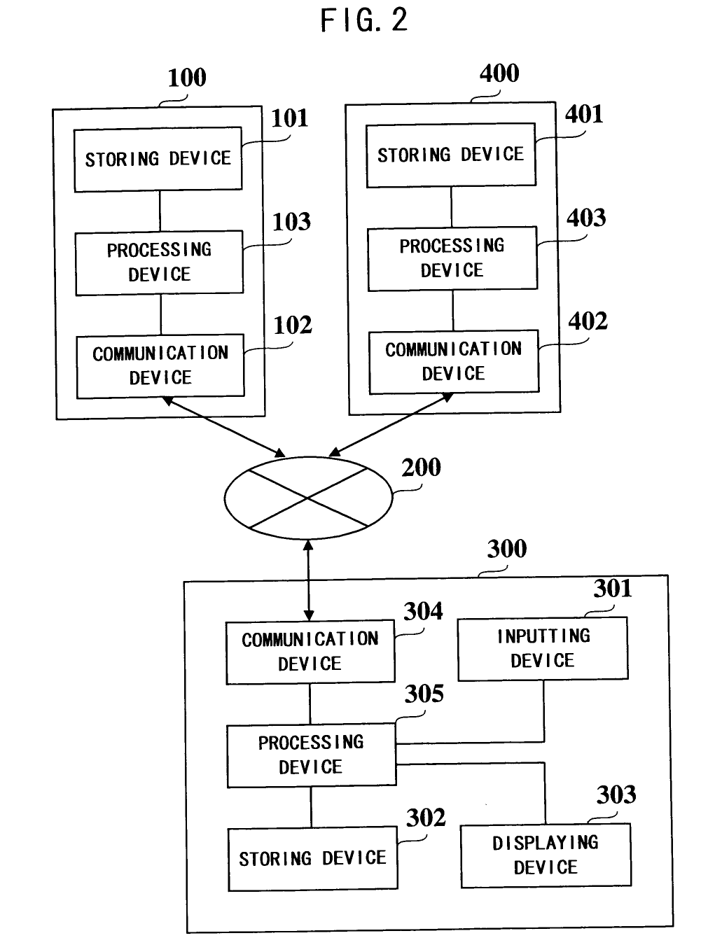

The address data management system 100 is applied in communication networks such as shown in FIG. 2. In FIG. 2, the address data management system 100 is connected to a user terminal 300, and a catalogue providing system 400 through a communication network 200. For example, the communication network 200 is a telecommunication link adequate for data communication, such as the internet, Ethernet (registered trademark), ISDN (Integrated Services Digital Network), and common carrier leased lines, etc. The communication network may include wireless communication link.

In the example shown in FIG. 2, the address data management system 100 is an HTTP (Hyper Text Transfer Protocol) server. The address data management system 100 in FIG. 2 comprises a storing device 101, a communication device 102, and a processing device 103.

The storing device 101 stores digital data and computer programs. For example, the storing device 101 is ROM (Read Only Memory), RAM (Random Access Memory), HDD (Hard Disk Drive), etc. The storing unit 101 may be physically dispersed to a plurality of memory systems. The address data storing unit 11, and the user data storing unit 20 are positioned as the storing device 101.

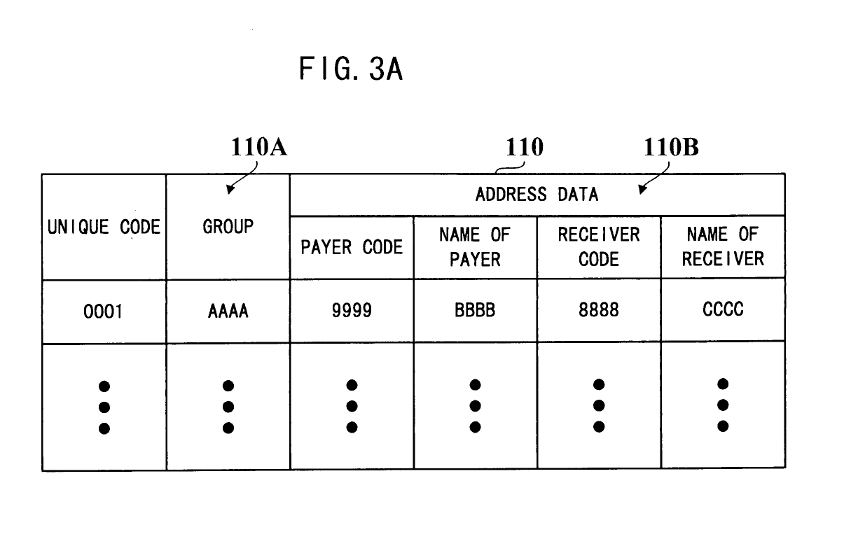

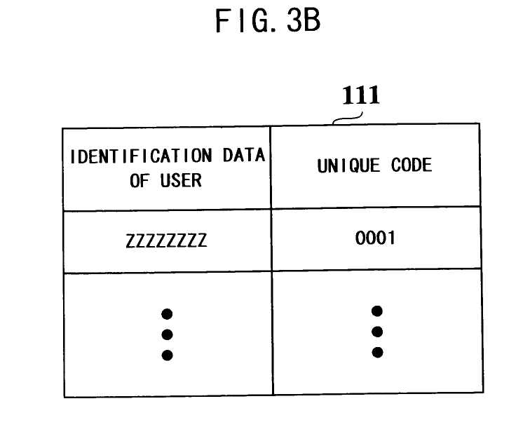

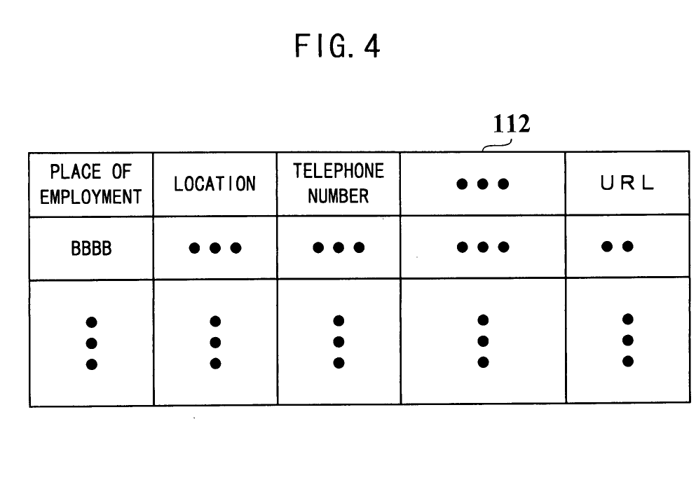

The address data storing unit 11 comprises a group identification file 110 shown in FIG. 3A, a user identification table 111 shown in FIG. 3B, and an address management database 112 shown in FIG. 4. As shown in FIG. 3A, the address data is categorized based on groups in the group identification file 110. Each record in the group identification file 110 has an unique code. A field “GROUP” 110A shown in FIG. 3A specifies an organization, by the name of a company or store. The field “ADDRESS DATA” 110B shown in FIG. 3A stores data relating to the delivery of the merchandise that was sold. For example, the field“ADDRESS DATA” 110B stores a data indicating the name of the receiver of the merchandise that was sold. In the field “ADDRESS DATA” 110B, the name of the receiver is corresponding to a receiver code. Furthermore, the field “ADDRESS DATA” 110B stores a data indicating the name of the payer of the merchandise that was sold. In the field “ADDRESS DATA” 110B, the name of the payer is corresponding to a payer code.

In the user identification table 111 shown in FIG. 3, identification data of the user is corresponding to an unique code. In the address management database 112 shown in FIG. 4, “PLACE OF EMPLOYMENT” indicates the name of the receiver or the name of the payer included in the field “ADDRESS DATA” 110B shown in FIG. 3A. In the address management database 112, the “PLACE OF EMPLOYMENT” corresponds to “LOCATION”, “TELEPHONE NUMBER”, “URL (Uniform Resource Locators)” etc.

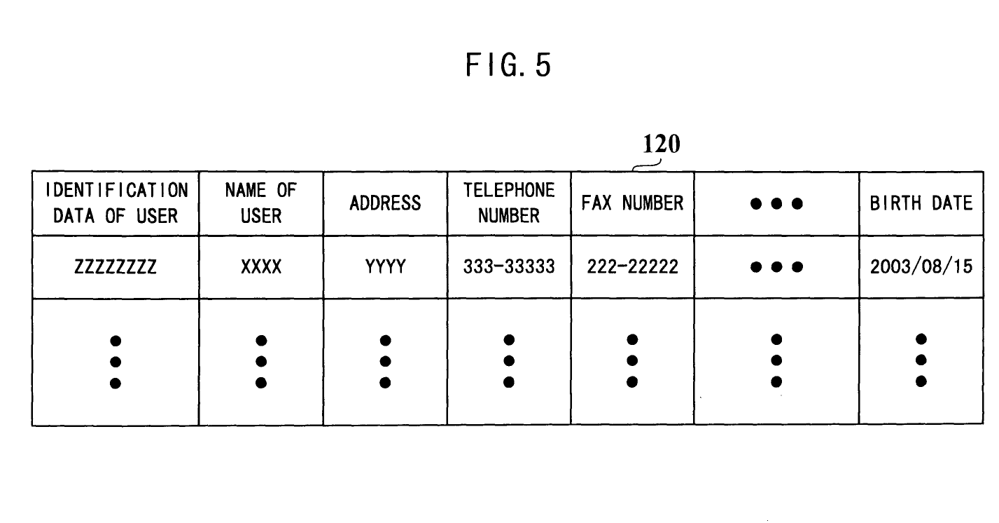

The user data storing unit 20 comprises a user management database 120 shown in FIG. 5. The “IDENTIFICATION DATA OF USER” in the user management database 120 shown in FIG. 5 includes the same data as the “IDENTIFICATION DATA OF USER” in the user identification table 111 shown in FIG. 3B. In the user management database 120, the “IDENTIFICATION DATA OF USER” is corresponding to “NAME OF USER”, “ADDRESS”, “TELEPHONE NUMBER”, “FAX NUMBER” “BIRTH DATE”, and etc.

The communication device 102 shown in FIG. 2 is used for sending and receiving data in the address data management system 100. For example, the communication device 102 is a network interface such as a network board. The processing device 103 controls operation of various devices included in the address data management system 100. For example, the processing device 103 is a CPU (Central Processing Unit). The identification data receiving unit 12, the address data extracting unit 13, the address output processing unit 14, the change request receiving unit 15, the change processing unit 16, the search request receiving unit 17, the search processing unit 18, and the search result output processing unit 19 are positioned as the processing device 103. The processing device 103 may be physically dispersed to a plurality of processing units.

In the example shown in FIG. 2, the catalogue providing system 400 comprises a storing device 401, a communication device 402, and a processing device 403. The catalogue providing system 400 provides a catalogue data of the merchandise sold by one or a plurality of distributors to the user terminal 300. In the catalogue providing system 400, the catalogue data is stored by the storing device 401. The catalogue data is provided to the user terminal 300 by the catalogue providing system 400, when the user inputs an order of a merchandise by the user terminal 300. For example, the catalogue data is a document data in an HTML (Hyper Text Markup Language) format. The communication device 402 is used for sending and receiving data in the catalogue providing system 400. For example, the communication device 402 is a network interface such as a network board. The processing device 403 controls operation of various devices included in the catalogue providing system 400. For example, the processing device 403 is a CPU.

In the example shown in FIG. 2, the user terminal 300 comprises an inputting device 301, a display device 302, a storing device 303, a communication device 304, and a processing device 305. For example, the user terminal 300 is a personal computer, portable phone, or PDA (Personal Digital Assistants), etc. To output information based on the data provided by the address data management system 100, and the catalogue providing system 400, a program such as a browser is installed in the user terminal 300.

The inputting device is used for inputting data by the user terminal 300. For example, the inputting device 301 is a keyboard, a mouse, a trackball, or a jog shuttle etc. The display device 302 outputs visualized information. For example, the display device is a CRT (Cathode Ray Tube) display, a plasma display, or a liquid crystal display, etc. The storing device 303 stores digital data and computer programs. For example, the storing device 303 is a ROM, a RAM, or an HIDD, etc. The communication device 304 is used for sending and receiving data by the user terminal 300. For example, the communication device 304 is a network interface such as a modem and a TA (Terminal Adapter). The processing device 305 controls operation of various device included in the user terminal 300. For example, the processing unit 305 is a CPU.

Next, the operation of the system according to the present invention will be described.

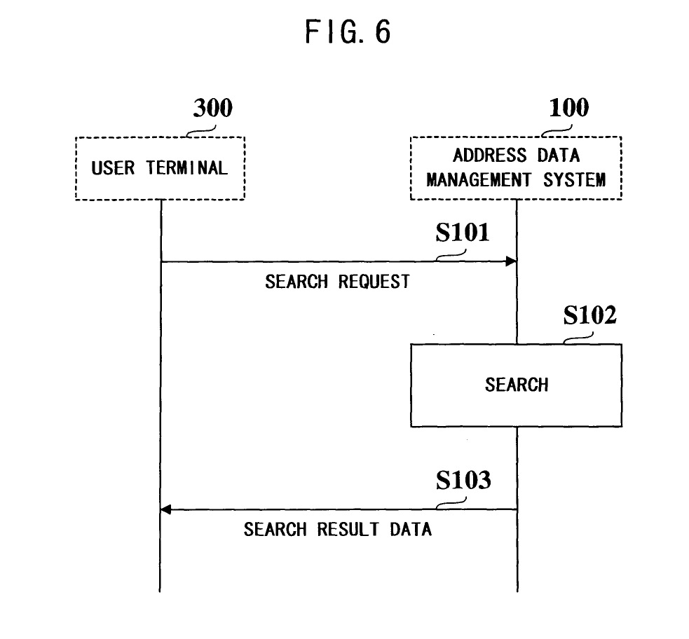

FIG. 6 is a process diagram showing the search processing carried out by the address data management system 100, and the user terminal 300.

The user terminal 300 establishes a network connection between the user terminal and the address data management system 100 by accessing to the address data management system 100 through the communication network 200. In the address data management system 100, the search request receiving unit 17 receives the search request sent from the user terminal 300 (Step S 101). The search request sent from the user terminal 300 has a structure of a pre-defined search query. For example, the search request includes a search parameter that designates at least one item among the post code, name of receiver, and address.

In the address management system 100, the search processing unit 18 searches for the data designated by the search request from the data stored in the address management database 112 (Step S 102). For example, the search processing unit 18 searches for the data that corresponds to the search parameter, from the data stored in the address management database 112. The result of the search by the search processing unit 18 is sent to the user terminal 300 by the search result output processing unit 19, as the search result data (Step S103). In the user terminal 300, the display device 302 displays the search result information based on the search result data received from the communication device 304.

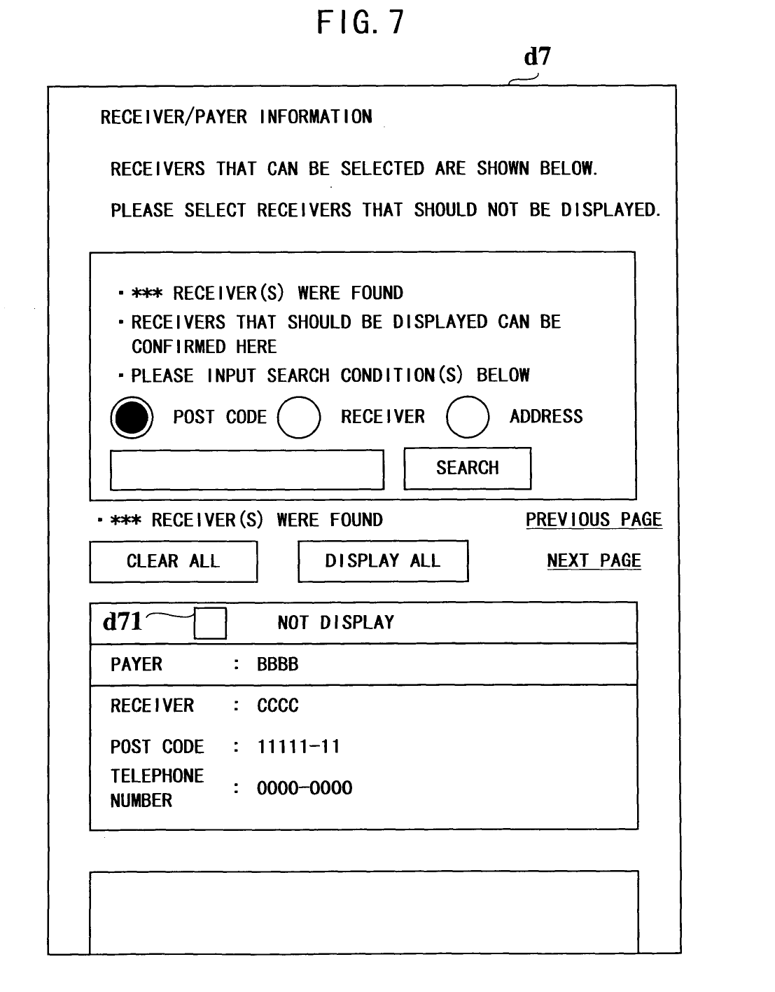

FIG. 7 shows an example of a search page displayed by the display device 302 of the user terminal 300. An image d7 shown in FIG. 7 includes an input area for inputting the search request, and an output area for displaying the search result. When a search result that matches the search request may not be gained, the display device 302 displays an image that shows a search error.

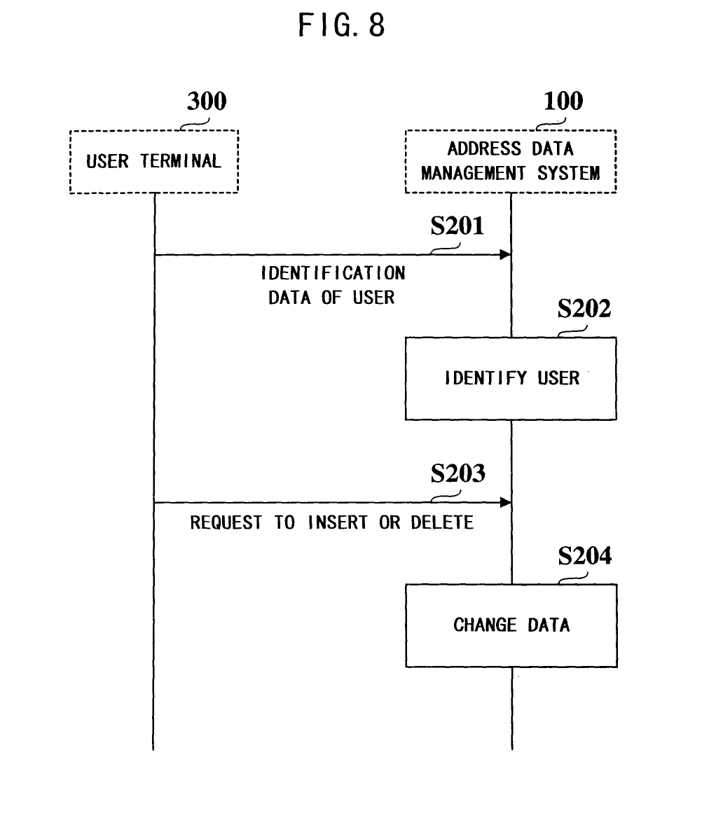

FIG. 8 is a process diagram showing a data customize processing executed by the address data management system 100 and the user terminal 300. The user terminal 300 sends the identification data of the user to the address data management system 100 to request a change in data (Step S201). The identification data of the user may be inputted by the inputting device 301, or may be stored in a predetermined region in the storing device 303. In the address data management system 100, the change request receiving unit 15 carries out an authentication processing to verify a user, by referring to the user identification table 111, based on the identification data of the user, received by the user terminal 300 (Step S202). After the authentication processing, the user terminal 300 sends the request to insert or delete address data, to the address data management system 100 (Step S 203).

The request to insert or delete address data is established according to an item selected at the image d7, shown in FIG. 7 by the user terminal 300. In the example shown in FIG. 7, when the checkbox d 71 is checked, the processing device 305 sends the request to insert data of the name of the receiver, to the address data management system 100. On the other hand, when the check of the checkbox d 71 is cleared, the process device sends the request to delete the data of the name of the receiver, to the address data management system 100. The request to delete address data designates a part of or the whole address data, correlated to the user in the group identification file 110, to be deleted.

In the address data management system 100, the change processing unit 16 changes the data stored in the group identification file 110, and the address management database 112 according to the request received by the change request receiving unit 15 (Step S 204).

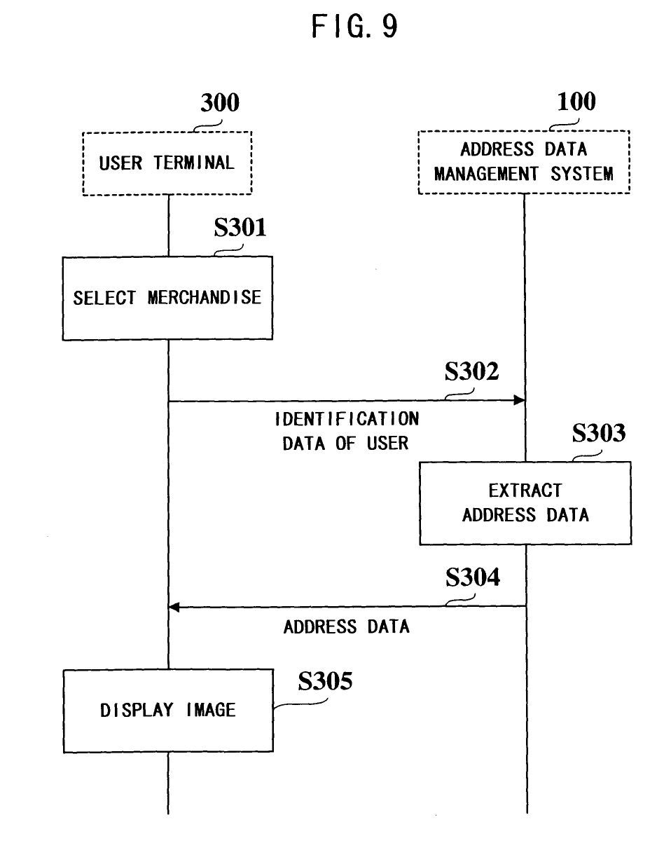

FIG. 9 is a process diagram showing an address selection processing carried out by the address data management system 100, and the user terminal 300. For example, when the user of the user terminal 300 orders a merchandise through the internet, the address selection processing is carried out. When the user orders a merchandise using the user terminal 300, the display device 302 displays an image to input an order, based on the catalogue data provided by the catalogue providing system 400. By using the inputting device 301, the user selects a merchandise in the image displayed by the display device 302 (Step S 301). It is possible to apply the well-known “shopping cart” model, for the selection of merchandise by the user terminal 300.

After merchandise being selected, the user terminal establishes a network connection between the user terminal 300 and the address data management system 100. In the address data management system 100, the identification data receiving unit 12 receives identification data of the users sent from the user terminal 300 (Step S 302). At this time, the identification data receiving unit 12 identifies the group in which the user belongs to. As one example, the identification data receiving unit 12 identifies which group the user belongs to, based on the characteristic parameter (for example, IP address, or MAC address, etc.), of the user terminal 300.

The address data extracting unit 13 extracts the address data from the group identification file 110, based on the identification data received from the identification receiving unit 12 (Step S 303). More specifically, the address data extracting unit 13 identifies the unique code that corresponds to the identification data by referring to the user identification table 111. The address data extracting unit 13 extracts the data that shows the name of the receiver, and the name of the payer, from the address data stored in the group identification file 110, based on the identified unique code, and the group in which the user belongs to. The address output processing unit 14 sends the data that was extracted from the address data extracting unit 13, to the user terminal 300 (Step S 304). For example, the address output processing unit 14 reads out the IP address stored in a predetermined region in the storing device 101, to identify the user terminal 300 which should be provided the data extracted by the address data extracting unit 13.

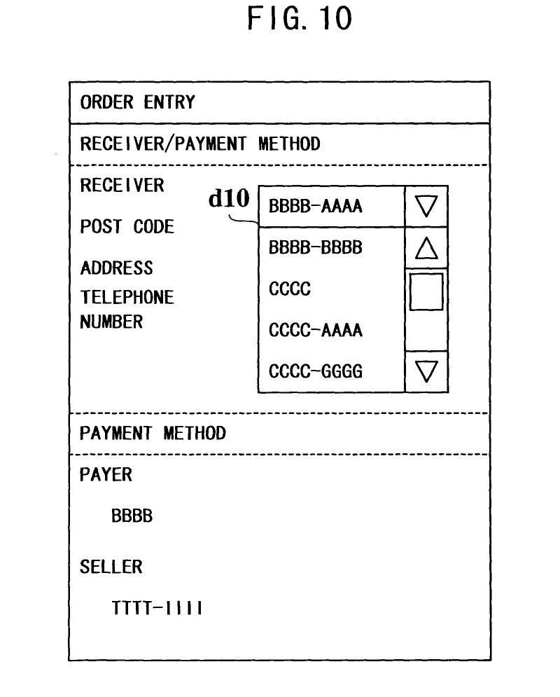

When the address data is delivered to the user terminal 300, the display device 302 of the user terminal 300 displays the image including the name of the receiver and the name of the payer, shown by the address data (Step S 305). FIG. 10 shows an example of an image displayed by the display device 302, based on the address data. The receiver of the merchandise may be displayed in a list box d10, as a factor of possible selection. When one receiver is selected by the list box d10, the terminal 300 sends a receiver data, showing the selected receiver, to the address data management system 100, and the catalogue providing system 400.

The image shown in FIG. 10 includes information of a payer of the merchandise, and a seller of the merchandise.

As described above, in the address data management system 100, the address data is categorized based on the group in which the user belongs to, and the identification data unique to the user inside the group. By this structure, the address data corresponding to the identification data is extracted from the group identification file 110, when the address data management system 100 receives the identification data of the user from the user terminal 300. Therefore, it is possible for the address data management system 100 to provide the adequate address data, in response to the user who needs the address data. By this address data management system 100, users who purchase merchandise can select the receiver and the payer of that merchandise efficiently.

Additionally, the address data management system 100 can change the data stored in the group identification file 110, and the address management database 112, in response to a request sent by the user terminal 300. By this operation, it is possible for the management system 100 to insert and delete address data corresponding to the identification data of the user. Therefore, the user can adequately set the receiver and payer of the merchandise.

The present invention may be realized by a general computer, without applying an exclusive system. The program and data for carrying out the above processing may be stored in a recording medium (magnetic storage, optical storage, magneto optical storage, IC memory, etc.), and distributed. The program is installed to the computer, the above processing is carried out by the OS (Operating System), and the system of the present invention is achieved. The above program and data may be stored in a disc device in a server on the internet, and superposed on a carrier. The program and data superposed on the carrier are downloaded by the computer, and the system of the present invention is realized.

Various embodiments and changes may be made thereunto without departing from the broad spirit and scope of the invention. The above-described embodiment is intended to illustrate the present invention, not to limit the scope of the present invention. The scope of the present invention is shown by the attached claims rather than the embodiment. Various modifications made within the meaning of an equivalent of the claims of the invention and within the claims are to be regarded to be in the scope of the present invention.

This application is based on Japanese Patent Application No. 2002-273543 filed on Sep. 19, 2002, and including specification, claims, drawings and summary. The disclosure of the above Japanese Patent Application is incorporated herein by reference in its entirety.

1. A system for managing address data comprising:
an address data storing unit which stores address data of users that are categorized based on groups in which each of the users belong to, and identification data unique to each of the user;
an identification data receiving unit which receives identification data of the users from user terminals;
an address data extracting unit which extracts address data, corresponding to the identification data received by said identification data receiving unit, from the address data stored in the address data storing unit; and
an address data output processing unit which outputs the address data extracted by said address data extracting unit to respective one of user terminals.

2. The system according to claim 1 further comprising:
a change request receiving unit which receives identification data of a user, and a request for changing the address data; and
a change processing unit which changes the address data stored in said address data storing unit, in response to the request received from said change request receiving unit,
wherein:
the request received from said change request receiving unit includes a first request for inserting address data, and a second request for deleting address data; and
said change processing unit
inserts new address data corresponding to the identification data of the user to the address data stored in said address data storing unit, when said change request receiving unit receives said first request, and
deletes a part of or the whole address data stored corresponding to the user in said address data storing unit, when said change request receiving unit receives said second request.

3. The system according to claim 1 wherein:
the address data stored in said address data storing unit includes receiver data showing the receiver of a merchandise, and a payer data showing a payer of the merchandise;
said address data extracting unit reads the receiver data and the payer data from said address data storing unit, in accordance with the identification data of the user received by said identification data receiving unit; and
said address data output unit sends the receiver data and the payer data read by said address data extracting unit, to said user terminal.

4. A method of managing address data, comprising:
storing address data of users, categorized based on groups in which each of users belong to, and identification data unique to each of the users, in a storing unit;
receiving identification data of a user from a user terminal;
reading address data, corresponding to the received identification data, from said data storing unit; and
providing read address data to a respective user terminal.

5. The method according to claim 4 further comprising:
receiving a request for changing the identification data of the user, and the address data, from said user terminal;
inserting new address data, corresponding to the identification data of the user, to the address data stored in said address data storing unit, when the request received from said user terminal is a first request for inserting address data; and
deleting a part of or the whole address data stored corresponding to the user in said address data storing unit, when the request received from said user terminal is a second request for deleting address data.

6. The method according to claim 4, wherein the address data stored in said data storing unit includes a receiver data that shows a receiver of a merchandise, and a payer data that shows a payer of a merchandise.

7. The method according to claim 6, wherein the receiver data and the payer data stored in said data storing unit are read, in accordance with the identification data of the user received by said user terminal, and the read receiver data and the payer data are sent to said user terminal.

8. A computer program comprising instructions for:
storing address data, categorized based on a group in which a user belongs to, and an identification data unique to the user, in a storing unit;
receiving identification data of the user from a user terminal;
reading address data, corresponding to the received identification data, from said data storing unit; and
providing the read address data to said user terminal.

9. The computer program according to claim 8 further comprising instructions for:
receiving a request for changing the identification data of the user, and the address data, from said user terminal;
inserting new address data, corresponding to the identification data of the user, to the address data stored in said address data storing unit, when the request received from said user terminal is a first request for inserting address data; and
deleting a part of or the whole address data stored corresponding to the user in said address data storing unit, when the request received from said user terminal is a second request for deleting address data.

10. The computer program according to claim 8 wherein the address data stored in said data storing unit includes a receiver data that shows a receiver of a merchandise, and a payer data that shows a payer of a merchandise.

11. The computer program according to claim 10 further comprising instructions for:
reading the receiver data and the payer data from said data storing unit, in accordance with the identification data of the user received by said user terminal; and
sending the read receiver data and the payer data to said user terminal.
